(19) United States
(12) Patent Application Publication
(10) Pub. No.: US 2001/0039818 A1
(43) Pub. Date: Nov. 15, 2001

(54) Pad lock

(76) Inventors: Steven W. Jones, Olympia, WA (US); Vince J. Conner, Tacoma, WA (US)

Correspondence Address: Richard C. Litman, LITMAN LAW OFFICES, LTD., P.O. Box 15035, Arlington, VA, 22215, US

(21) Appl. No.: 09/851,244

(22) Filed: May 9, 2001

Related U.S. Application Data
(60) Provisional application No. 60/203,940, filed on May 12, 2000.

(51) Int. Cl. E05B 37/02

(52) U.S. Cl. 70/308

(57) ABSTRACT

A pad lock mechanism is described having a body portion and a latch which cooperate to lock and unlock the device. The body portion has at least one body core and a biasing element disposed within the body core for biasing or displacing the latch a predetermined depth therein. The body core includes a locking mechanism and at least two channels for insertably receiving a latch. The lock mechanism is unlocked via a multipurpose key element which is configured to operate via a single handcuff key which alleviates worry associated with trying to find a single key from a ring having numerous keys thereon. The lock mechanism utilizes a simple T-shaped structure which forms a locking arrangement via single and dual recess latch configurations. The lock is made from a durable metal material which is impervious to rust and corrosion.

### CROSS-REFERENCE TO RELATED APPLICATION

This application claims the benefit of U.S. Provisional Patent application Ser. No. 60/203,940, filed May 12, 2000.

### BACKGROUND OF THE INVENTION

1. Field of the Invention

The present invention relates generally to padlocks. More specifically, the invention is a padlock mechanism which utilizes a universal handcuff key for multiple device applications.

2. Description of Related Art

Numerous locking mechanisms have been devised for providing minimum to maximum levels of security to secure items whether in the work place or in the home, however these conventional devices as will be described in more detail hereinbelow require numerous mechanical parts to configure a single lock mechanism. These devices are costly to manufacture compared to the instant invention, and such devices require the addition of at least one key per pad lock. Having to carry numerous keys is one significant problem that workers in law enforcement complains. Having to find a single key for unlocking a secured area, where time is of the essence becomes nearly impossible to secure an area in a timely manner. A pad lock which utilizes a single key for multiple applications as herein described is lacking.

For example, U.S. Pat. No. 3,661,000, issued to Kerr, discloses a tumbler lock having a spring-biased key ejector for ejecting a key in any angular position with respect to a plug, such as in the locked position, or any intermediate position.

U.S. Pat. No. 3,823,585, issued to Spon, discloses an improved door latch set which may be converted from a basic latch set into a privacy latch set or into a key lock latch set. The set includes a latch assembly, an inside doorknob assembly, and an t outside doorknob assembly. The doorknob assemblies are interconnected by a spindle which fits through a cam of the latch assembly. Rotation of the doorknob drives the cam which, in turn, moves the bolt of the latch assembly into or out of engagement with a strike. The inside doorknob assembly may include a push button lock mechanism which locks the set upon depression of the push button. The locked latch set may be released by twisting the inside doorknob or by a key mechanism associated with the outside doorknob. Rotation of the key mechanism drives a latching bar connected with the push button mechanism and, thereby, affects release of the push button mechanism.

U.S. Pat. No. 5,211,044, issued to Kim, presents a universal lock and key assembly in which the lock is re-keyable and the key is changeable. The key has a shank portion having a longitudinally extending tooth slot in its top surface. A plurality of teeth have bottom ends inserted into the tooth slot to give a predetermined profile to the teeth of the key. The bottom pin cylinder of the lock has mating bottom pins for each of the respective teeth. These bottom pins are arranged in a coordinated sequence in the bottom pin cylinder of the lock. The structure of the system allows an individual to change both the configuration of the key and also the mating structure within the lock so it will be operable.

U.S. Pat. No. 5,582,042, issued to Mordick, shows a double lock apparatus comprising interconnected locking members connected by a retainer pin. The members include arcing slots and a pair of orifices. Each of the locking members includes an arcing slot arcing in an opposite direction and centered on the opposite portion of the orifices. The external lock members insert through the orifices to prevent pivoting. Removal of one of the external lock members allows pivoting about the other lock member with the retainer pin sliding along one of the arcing slots. The pivoting motion separates retainer finger portions to allow unlatching.

U.S. Pat. No. 5,638, shows a universal backup handcuff key comprising a round and flat molded device not readily identifiable as a handcuff key, which can be hidden under a wrist watch or behind a standard shirt button of a law enforcement officer or security person and which can be silently retrieved and utilized by bending the key portion partially out of the surrounding molded support ring structure with the use of the thumb, index finger, and middle finger.

U.S. Pat. No. 5,775,148, issued to Layton et al., discusses an apparatus for use with electronic and/or mechanical access control devices comprising a holder which receives a removable insert which may include an electronic module with a cover member securing the insert to the holder. The holder may take various forms and may be have alternative design embodiments such as a key ring or photo I.D. card. The holder may be a key blank for forming a key that operates mechanical locks, in which case the insert may be a dummy insert or it may include electronic components for operating various types of electronic access control devices.

U.S. Pat. No. 5,913,666, issued to Perkins, discloses an apparatus and method for securing a firearm from firing by engaging a security lock to a slide at a butt end of the firearm. The security lock has a housing defined by a pair of sidewalls joined by a top plate that defines a slot for receiving a sight on the slide. A controller extends through a rear plate of the housing. A security member is operatively engaged to the controller for being moved between a first position for installing and removing the housing from the slide of the handgun and a second position in which the security member operatively secures the housing to the slide by being disposed between the rear portion of the slide and the handle of the firearm.

U.S. Pat. No. 5,752,400, issued to Kim discusses a universal lock and key assembly in which the lock is re-keyable, and the key is changeable. The key has an elongated left side member, an elongated right side member, and an elongated central member. A plurality of key teeth are captured between the shank portions of the left and right side members. The key teeth are interchangeable so that any desired sequence can be arranged to give a predetermined profile to the key. The universal lock has a combination top pin housing and a tubular sleeve assembly having a top pin housing and a tubular sleeve portion. A bottom pin cylinder is removably received in the tubular sleeve portion and its bottom pins can be removed and replaced in an order that mates with the key teeth of the key assembly.

U.S. Pat. No. 5,758,525, issued to Goldman, discloses a lock and key wherein the key is used in conjunction with the lock. The stop bit and each coding bit have a leading edge and a trailing edge to provide coding of the key and to form one side of the groove. The lock has a housing having a key-actuated cogwheel assembly. The cogwheels are registered with a keyhole and are spaced for engagement by the coding bits of the key. A driven cogwheel assembly has a series of cogwheels that mesh with a corresponding key-actuated cogwheel.

The British patent granted to Skrzepinski (GB 251,106) discloses a permutation lock comprising a locking bolt provided with a number of notches and a corresponding number of longitudinally movable rotatable locking disks normally engaging the notches of the locking bolt and provided with release notches. Also included are gears connected with the locking disks and tooth sectors or racks adapted to be clutched to the gears in variable positions for the purpose of changing the combination of the lock. The French Patent granted to Cosnard (FR 2,646,820) is of general relevance to the invention. And finally. U.S. Design Pat. No. 244,667, issued to Craft, illustrates a handcuff lock key.

None of the above inventions and patents, taken either singly or in combination, is seen to describe the instant invention as claimed.

### SUMMARY OF THE INVENTION

The pad lock mechanism according to the invention has a body portion and a latch which cooperate to lock and unlock the device. The body portion has at least one body core and a biasing element disposed within the at least one body core for biasing or displacing the latch a predetermined depth therein. The at least one body core include a locking mechanism and at least two channels for insertably receiving a latch. The lock mechanism is unlocked via a multipurpose key element. The lock is configured to operate via a single handcuff key thereby alleviating the worry associated with obtaining keys when time is of the essence from a group of otherwise similar keys on a ring. This is rather significant in law enforcement. The lock according to the invention is simple in construction and easy to operate. A spring loaded latch is provided to sufficient bias or force the latch in an opened position for quick release and use.

Accordingly, it is a principal object of the invention to provide a pad lock as a first level security mechanism. It is another object of the invention to provide a pad lock which is accessible via a single handcuff key element.

It is a further object of the invention to provide a pad lock with a body central key access aperture.

Still another object of the invention is to provide a pad lock with a base central key access aperture.

Further still, another object is to provide a lock mechanism which is simple in construction and requires a minimum number of mechanical elements for manufacturing and operation.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a pad lock according to the present invention.

FIG. 2 is an exploded view of the pad lock and key mechanism according to a first embodiment.

FIG. 3 is an exploded view of the pad lock and key mechanism according to a second embodiment.

FIG. 4 is a perspective side view of the pad lock according to invention, illustrating the pad lock in a locked position.

FIG. 5A is a perspective side view of the pad lock according to a third embodiment of the invention, illustrating a pad lock mechanism with pins and tumblers.

FIG. 5B is a bottom perspective view of the pad lock of FIG. 5A.

Similar reference characters denote corresponding features consistently throughout the attached drawings.

### DETAILED DESCRIPTION OF THE PREFERRED EMBODIMENTS

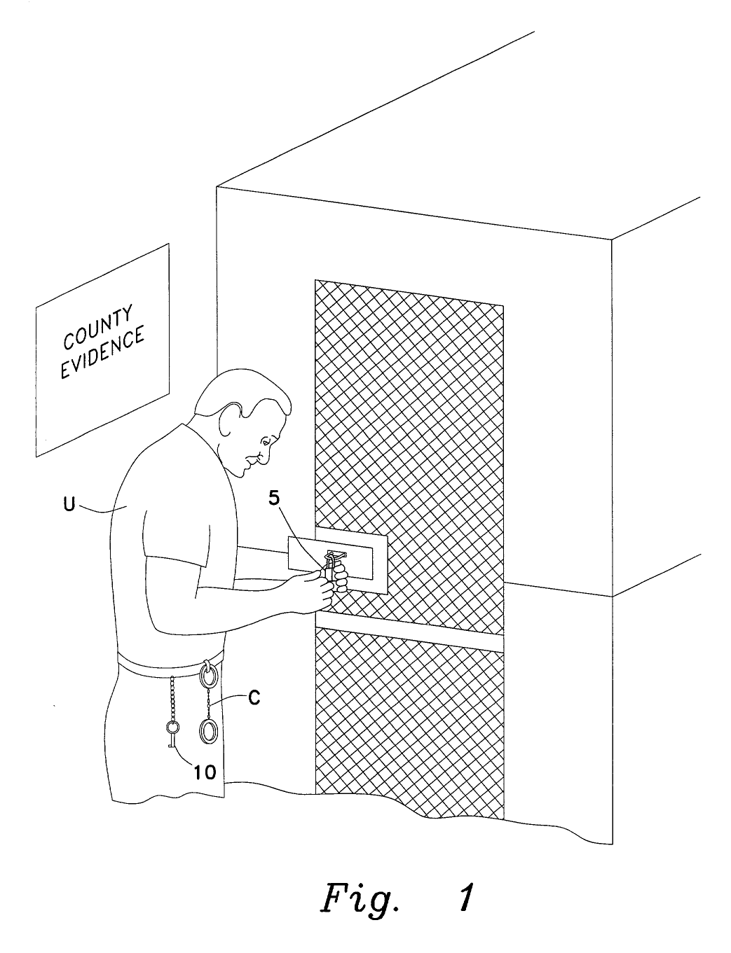

The present invention is directed to a pad lock mechanism which provides simple access and manipulation thereto as a first level security device, preferably for law enforcement personnel U. The preferred embodiments of the present invention are depicted in FIGS. 1-5B, and are generally referenced by numerals 5, 6 and 7, respectively.

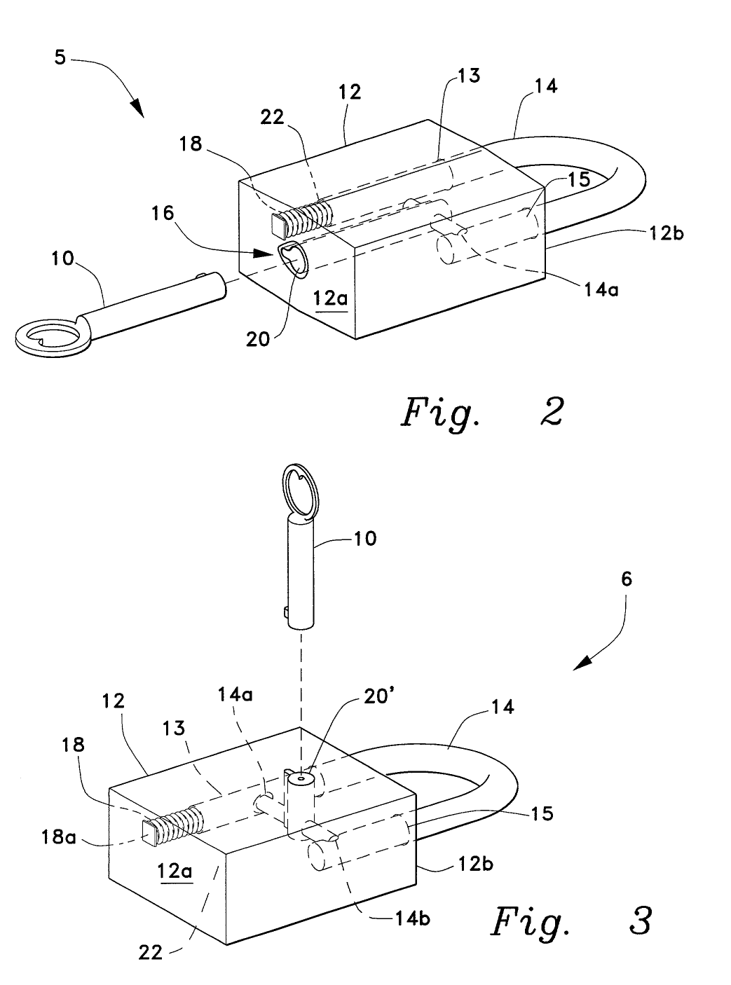

As diagrammatically illustrated in FIG. 1, a law enforcement worker U is shown securing the pad lock 5 to a door latch of a storage facility according to a first embodiment. As shown therein the worker U is ladened with multiple devices namely a pair of handcuffs C and the pad lock 5 which are both accessed by a single universal handcuff key 10. As diagrammatically illustrated in FIG. 2, the pad lock 5 according to the first embodiment comprises a body portion 12 and a latch 14. The body portion 12 has at least one body core 16, a biasing means or mechanical spring having a predetermined area (meters²), unstretched length (meters) and stiffness (in units of Newtons/meter (N/m) 18 disposed within the at least one body core 16 for biasing the latch 14 a predetermined depth therein.

Other cores of the body include off-set latch cores 13 and 15 which provide insertable channels for receiving a first and second end of the latch 14. Between these two cores 13,15, there is disposed a lock mechanism 20 for locking/unlocking the latch 14 via a single recesses 14a via key 10 or alternatively as a dual recess latch arrangement 14a and 14b via key 10. The lock mechanism 20 is preferably made of a substantially T-shaped cylindrical structure shaped to form a key way element. This key way element 20 serves as a male type key way connector for the key 10. The key 10 according to this type of lock mechanism 20 is a female type element for insertably attaching to the T-shaped locking element as a male and female attachment.

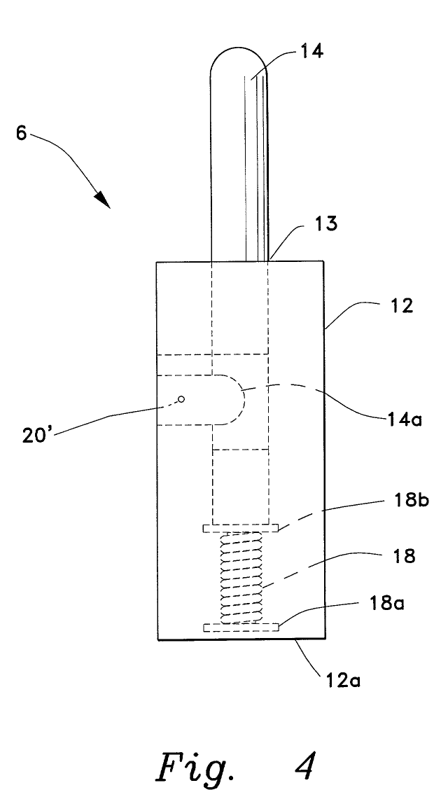

As diagrammatically illustrated in both FIGS. 2 and 3, the lock according to both embodiments 5 and 6, is shown wherein the latch 14 is substantially U-shaped and of cylindrical construction. The lock according the invention, further comprises a first and second recess for rotatable and locking attachment with opposing portions of the T-shaped element. Other similar structural features include wherein the body portion 12 is substantially rectangular. Other geometric configurations can be used so long as such configurations are used within the scope and intent of the invention as herein disclosed.

In each instance, the body portion 12 and latch 14 cooperate to allow the opening and closing of the pad lock 5,6 with the key 20, respectively. With more particularity, both FIGS. 2 and 3 show wherein the lock mechanism 20 and latch 14 are disposed in opposing wall portions of the rectangular body 12. As shown therein, the pad lock 5 is centrally disposed within the body portion 12 whereby the wall portion 12a opposite the latch wall portion 12b defines a key way for the lock mechanism 20. The biasing means 18 is preferably a mechanical spring having a predetermined stretch length, area and stiffness for displacing a first portion 22 of the latch 14 a predetermined distance within the body portion or channel 13 of the lock 5. Accordingly, the spring 18 and first portion 22 of the latch 14 are disposed in co-linear and in selective abutment relation. The spring 18 is anchored at a base portion 18a of the pad lock 5.

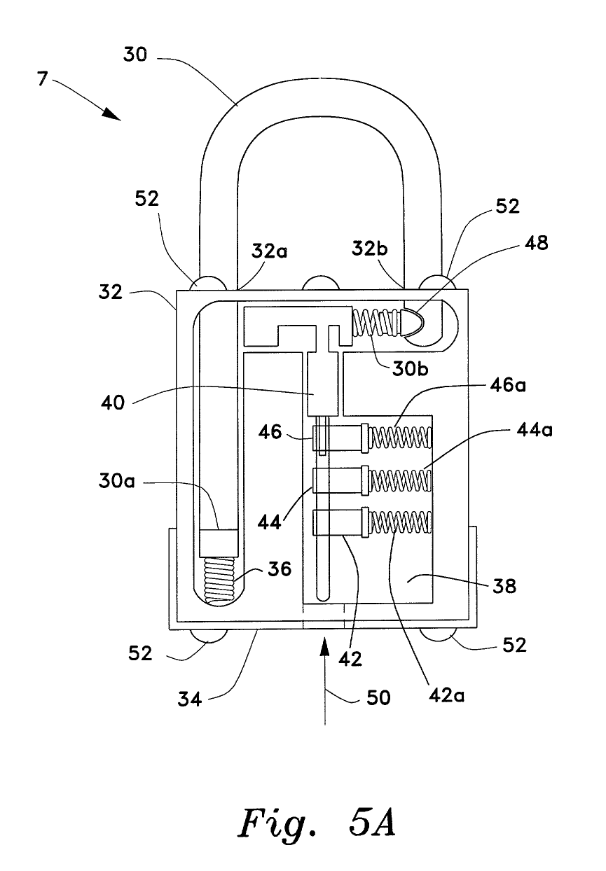

According to the second embodiment 6, FIG. 3 illustrates similar structural features as that described in the first embodiment except wherein the locking mechanism 20′ is disposed in a substantially central portion of the body 12 in orthogonal relation with the latch 14 and cooperating with the dual latch recess arrangement 14a and 14b. FIG. 4 illustrates in a side perspective view how the latch 14, and biasing means 18 cooperate to form a locked configuration.

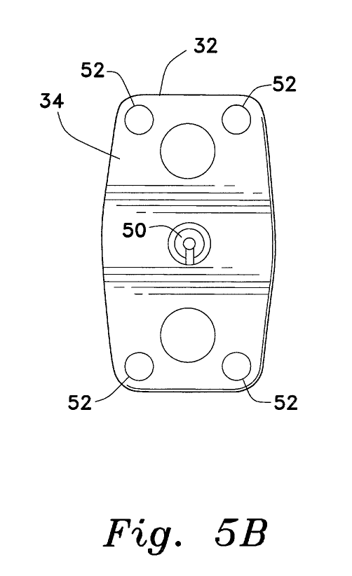

According to the third embodiment 7, FIGS. 5A and 5B illustrate a lock 7 having structural features such as a shackle 30, a body portion 32 and an interior manipulable locking mechanism 40 which is also manipulable by a single handcuff key via a direction arrow 50. The operative features of the lock 7 are similar to the first and second embodiments 5 and 6, except that the locking mechanism 40 is a pin and tumbler operable lock mechanism 40. A central portion of the body 32 is configured in a conventional manner (i.e. as a multi-layered metal plate assembly secured at adjoining ends via a series of metal pin or bolt fasteners 52).

The body portion 32 of the lock 7 has a first and second aperture 32a and 32b for respectively retaining the shackle 30, and an interior core 38 which houses the centrally disposed lock mechanism 40. The lock mechanism 40 constitutes a rotatable bolt mechanism having a spring loaded catch 30b for retaining a recess portion 48 disposed in an end of the U-shaped shackle 30 via body aperture 32b. The other end 30a of the shackle 30 is insertably housed within the body 32 along its length via aperture 32a. The end 30a terminates within the body 32 via a biasing means or spring 36. The spring 36 and spring loaded catch 30b are configured with the same rigidity or spring constant k, in Newtons per meter, (N/m). With respect to the pin and tumbler elements 42, 44, 46 and corresponding spring elements 42a, 44a and 46a, it is preferred that the respective spring elements 42a, 44a and 46a be configured with the same spring constant k₂ (in units of Newtons per meter) having a biasing rigidity significantly less than k, by at least 24 orders of magnitude less. Each respective pin and tumbler is secured to an adjacent wall portion within the cavity 38 of the body 32. A single handcuff key 10 activates the locking mechanism 40 via a central key-way aperture disposed within the base 34 as indicated by the direction arrow 50. The handcuff key 10 serves to selectively and operatively secure or release the shackle 30 to or from the body 32. As diagrammatically illustrated in FIG. 5B, the base 34 of the of the lock 7 is shown illustrating the handcuff key-way 50 and plate fasteners or bolts 52. Other locking elements or features such as a removable cylinder plug can be used to operatively secure or release the shackle 30 from the body 32, respectively via a single handcuff key 10.

Noted advantages of the invention as herein described include numerous uses of lock mechanisms 5, 6 and 7 in applications involving belly/waist chains for transporting inmates; facilities such as supply closets, tool sheds and lockers, first aid kits, fire extinguisher boxes, laundry and food carts, window covers on doors, Inmate property bags, trap doors and feeding doors; areas accessible only to prison staff such as behind washer and dryers where Inmates try to light cigarettes via the power supply; patrol officer's equipment bags and boxes transported in trunks of vehicles; shot gun racks, officer lockers, inmate transport wagons and equipment areas which include desk locks for supervision facilities.

Accordingly, the lock according to the invention gives staff in a prison facility ready access to minimally secured areas. It makes transporting inmates simple, quick and secure without having to perform an un-restraining procedure on the inmates when conveying inmates to receiving officers. It saves agencies money by eliminating the expenses associated with reproducing keys and outfitting each staff member with a plurality of different keys to various conventional locks. In sum, the invention save facilities money, eliminates the hassles with standard or conventional locks by providing ready access to minimally secured areas, hazard areas and restrained inmates during or for a medical emergency via a single handcuff key 10.

It is to be understood that the present invention is not limited to the embodiments described above, but encompasses any and all embodiments within the scope of the following claims.

We claim:

1. A pad lock for use with a handcuff key comprising:
a pad lock having a body portion and a latch, said body portion having at least one body core, a biasing means disposed within said at least one body core for biasing the latch a predetermined depth therein, said at least one body core comprising a lock mechanism for locking the latch therein via said key, the body portion and latch cooperate to open and close the pad lock with the key respectively.

2. The lock according to claim 1, wherein said body portion is a substantially rectangular body portion.

3. The lock according to claim 2, wherein said lock mechanism and latch are disposed in opposing wall portions of said body.

4. The lock according to claim 3, wherein said lock mechanism is centrally disposed within said body portion wherein the wall portion opposite said latch wall portion defines a key way for the lock mechanism.

5. The lock according to claim 2, wherein said biasing means is a mechanical spring having a predetermine area and stiffness for displacing a first portion of the latch a predetermined distance within the body potion of the lock. said body.

6. The lock according to claim 5, wherein said spring and said first portion of the latch are disposed in co-linear and in selective abutment relation, the spring being anchored at a base portion of the pad lock.

7. The lock according to claim 1, wherein said lock mechanism comprises a substantially T-shaped cylindrical key way element as a male key way connector for said key, wherein said key is a female element for insertably attaching to said T-shaped element as a male and female attachment.

8. The lock according to claim 7, wherein said latch is substantially U-shaped and cylindrical in construction.

9. The lock according to claim 8, further comprising a first and second recess for rotatable and locking attachment with opposing portions of said T-shaped element.

10. The lock according to claim 1, wherein said locking mechanism is disposed in a substantially central portion of the body in orthogonal relation with the latch.

11. A pad lock for use with a handcuff key comprising, in combination with at least one door latch of a storage facility:
a pad lock having a body portion and a latch, said body portion having at least one body core, a biasing means disposed within said at least one body core for biasing the latch a predetermined depth therein, said at least one body core comprising a lock mechanism having a pin and tumbler system for locking the latch therein via said key, the body portion and latch cooperate to open and close the pad lock with the key respectively.

12. The lock according to claim 11, wherein said body portion is a substantially rectangular body portion.

13. The lock according to claim 12, wherein said lock mechanism and latch are disposed in opposing wall portions of said body.

14. The lock according to claim 13, wherein said lock mechanism is centrally disposed within said body portion wherein the wall portion opposite said latch wall portion defines a key way for the lock mechanism.

15. The lock according to claim 12, wherein said biasing means is a mechanical spring having a predetermine area and stiffness for displacing a first portion of the latch a predetermined distance within the body potion of the lock. said body.

16. The lock according to claim 15, wherein said spring and said first portion of the latch are disposed in co-linear and in selective abutment relation, the spring being anchored at a base portion of the pad lock.

17. The lock according to claim 11, wherein said lock mechanism comprises a substantially T-shaped cylindrical key way element as a male key way connector for said key, wherein said key is a female element for insertably attaching to said T-shaped 5 element as a male and female attachment.

18. The lock according to claim 17, wherein said latch is substantially U-shaped and cylindrical in construction.

19. The lock according to claim 18, further comprising a first and second recess for rotatable and locking attachment with opposing portions of said T-shaped element.

20. The lock according to claim 11, wherein said locking mechanism is disposed in a substantially central portion of the body in orthogonal relation with the latch.
